(19) United States
(12) Patent Application Publication
(10) Pub. No.: US 2025/0021343 A1
(43) Pub. Date: Jan. 16, 2025

(54) CONFIGURATION DATA MANAGEMENT

(71) Applicant: Oracle International Corporation, Redwood City, CA (US)

(72) Inventors: Rohit Juneja, Stittsville (CA); Sandesh Pai, Chelmsford, MA (US)

(21) Appl. No.: 18/351,896

(22) Filed: Jul. 13, 2023

(51) Int. Cl. G06F 9/445

(52) U.S. Cl. CPC G06F 9/44505

(57) ABSTRACT

Various embodiments of the present technology generally relate to systems and methods for managing configuration data in a virtual or containerized software environment. A configuration data management system may enable ConfigMaps to be added to an application pod of a virtual software environment without restarting the application pod, a ConfigMap including a data object containing configuration data. The configuration data management process may monitor for creation of a first ConfigMap in the virtual software environment, append a name of the first ConfigMap to a data element name from the first ConfigMap to produce an appended data element, and store the appended data element to a super ConfigMap, the super ConfigMap including a specialized ConfigMap configured to contain data elements from multiple ConfigMaps.

### TECHNICAL FIELD

Various embodiments of the present technology generally relate to management of configuration data within a software container environment, such as Kubernetes® (sometimes stylized as K8s). More specifically, embodiments of the present technology relate to systems and methods for the addition or removal of configuration data files from application pods without the need to restart the application pod.

### BACKGROUND

In containerized software environments such as Kubernetes, non-confidential data such as configuration files, environment data, and command-line arguments may be stored in a data object called a “ConfigMap”. As used herein. ConfigMap may generally refer to non-confidential data that a pod or application may access while running, such as configuration data and variables. ConfigMap data may take the form of key-value pairs of strings or other variable or value objects. In order to provide a pod or application with access to the ConfigMap, the ConfigMap may need to be mounted to the pod or software, creating a directory or volume accessible by the pod or application. However, adding new ConfigMaps, or removing existing ConfigMaps, may require mounting or removing a directory or volume, which in turn may require restarting a pod and associated microservices or applications. Restarting a pod in this manner can cause service impacts or potential service downtime, lowering a quality of service and degrading client satisfaction. Accordingly, there exists a need for improved management of configuration data.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing configuration data management. In an embodiment, a configuration data management system may comprise one or more processors, and a memory having stored thereon instructions that, upon execution by the one or more processors, cause the one or more processors to implement a configuration data management process to enable ConfigMaps to be added to an application pod of a virtual software environment without restarting the application pod, a ConfigMap including a data object containing configuration data. The configuration data management process may monitor for creation of a first ConfigMap in the virtual software environment, append a name of the first ConfigMap to a data element name from the first ConfigMap to produce an appended data element, and store the appended data element to a super ConfigMap, the super ConfigMap including a specialized ConfigMap configured to contain data elements from multiple ConfigMaps.

In some embodiments, the configuration data management system may determine whether the first ConfigMap includes a selected metadata label, and in response to determining the first ConfigMap includes the selected metadata label, determine a first value associated with the selected metadata label and a first namespace associated with the first ConfigMap, and determine whether the first value corresponds to an existing super ConfigMap in the first namespace. In response to determining the first value does correspond to an existing super ConfigMap in the first namespace, the configuration data management system may store the appended data element to the super ConfigMap as the existing super ConfigMap. In response to determining the first value does not correspond to an existing super ConfigMap in the first namespace, the configuration data management system may generate the super ConfigMap, including setting a name for the super ConfigMap based on the first value. The configuration data management system may mount the super ConfigMap to the application pod during initialization of the application pod, including storing the appended data element to a directory accessible to the application pod. In some embodiments, the configuration data management system may detect creation of a second ConfigMap having a second namespace associated with the second ConfigMap, the selected metadata label, and a second value associated with the selected metadata label that is the same as the first value. The configuration data management system may determine whether the second namespace is the same as the first namespace, and when the second namespace is different than the first namespace, generate a new super ConfigMap in the second namespace, and store a second appended data element from the second ConfigMap to the new super ConfigMap. When the second namespace is the same as the first namespace, the configuration data management system may store the second appended data element from the second ConfigMap to the super ConfigMap in the first namespace. In some implementations, the configuration data management system, in response to the first ConfigMap not including the selected metadata label, may not append the name of the first Configmap to the data element name or store the appended data element to the super ConfigMap. The configuration data management system may mount the super ConfigMap to the application pod to provide a directory via which the application pod can access the appended data element, and configure the super ConfigMap such that additional appended data elements from ConfigMaps can be added to or removed from the directory during operation of the application pod, without requiring a restart of the application pod. In some embodiments, the configuration data management system may detect creation of a second ConfigMap in the virtual software environment, append a second name of the second ConfigMap to a second data element from the second ConfigMap to produce a second appended data element, and store the second appended data element to the super ConfigMap. The configuration data management system may initiate the virtual software environment as a Kubernetes cluster, initiate the application pod after initiation of the Kubernetes cluster, mount the super ConfigMap to the application pod during initiation of the application pod, add data element key files to the super ConfigMap without restarting the application pod; and remove the data element key files from the super ConfigMap without restarting the application pod.

In an alternative embodiment, a method may comprise operating a configuration data management system to ConfigMaps to be added to an application pod of a virtual software environment without restarting the application pod, a ConfigMap including a data object containing configuration data, including monitoring for creation of a first ConfigMap in the virtual software environment, appending a selected value derived from the first ConfigMap to a data element name from the first ConfigMap to produce an appended data element, and storing the appended data element to a super ConfigMap, the super ConfigMap including a specialized ConfigMap configured to contain data elements from multiple ConfigMaps.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to perform configuration data management, in accordance with certain embodiments of the present disclosure;

FIG. 2 is a diagram of a system configured to perform configuration data management, in accordance with certain embodiments of the present disclosure;

FIG. 3 is a diagram of a system configured to perform configuration data management, in accordance with certain embodiments of the present disclosure;

FIG. 4 is a diagram of a system configured to perform configuration data management, in accordance with certain embodiments of the present disclosure;

FIG. 5 is a diagram of a system configured to perform configuration data management, in accordance with certain embodiments of the present disclosure;

FIG. 6 is a diagram of a system configured to perform configuration data management, in accordance with certain embodiments of the present disclosure;

FIG. 7 depicts a flowchart of an example method to perform configuration data management, in accordance with certain embodiments of the present disclosure;

FIG. 8 depicts a flowchart of an example method to perform configuration data management, in accordance with certain embodiments of the present disclosure; and

FIG. 9 illustrates a computing system configured to perform configuration data management, in accordance with some embodiments of the present technology.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

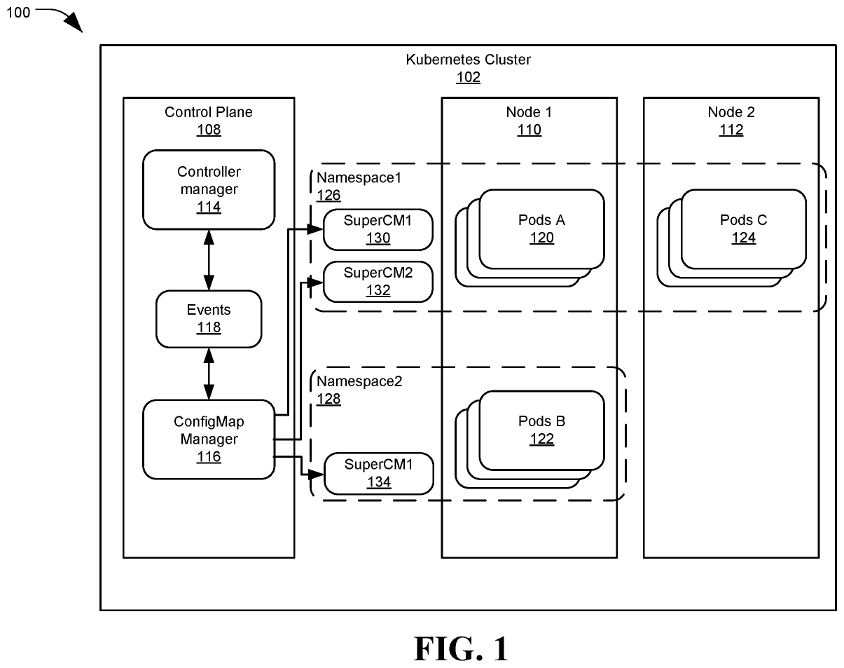

FIG. 1 is a diagram of a system 100 configured to perform configuration data management, in accordance with certain embodiments of the present disclosure. The example system 100 may include a Kubernetes container orchestration system, although the present disclosure may apply to other containerized application systems. Containers may refer to a virtualized software execution environment, in which applications running within the container only have access to resources assigned to the container, rather than all resources of the underlying physical computing system on which the container is running. For example, a container may include a Linux executable packaged with all necessary dependency and configuration files, such that the container is self-sufficient for running all applications of the container. The system 100 may include a Kubernetes cluster 102, which may include a set of components used to implement containerized applications. The cluster 102 may include a control plane 108, and one or more nodes, such as Node 1 110 and Node 2 112.

The nodes 110, 112 may include worker machines that each host one or more pods, such as Pods A 120 and Pods B 122 of Node 1 110, and Pods C 124 of Node 2 112. A pod may model an application-specific “logical host”, and may contain one or more applications, with shared storage and network resources, and a specification for how to run the containers. A pod's contents may be co-located and co-scheduled, and may be run in a shared context. Pods may be grouped according to a namespace, such as Namespace 1 126 and Namespace 2 128.

Namespaces 126, 128 may provide a mechanism for isolating groups of resources within a single cluster 102. Names of resources may need to be unique within a namespace, but not between different namespaces. Namespaces may provide a way to divide cluster 102 resources between multiple users (e.g., via resource quotas). Namespaces may include multiple pods distributed across multiple nodes, or may only include one or more pod from a single node. In the depicted example of FIG. 1, Namespace 1 126 may include Pods A 120 from Node 1 110 and Pods C 124 from Node 2 112, while Namespace 2 128 may only include Pods B 122 from Node 1 110.

A control plane 108 may include one or more components, such as software modules and data structures, which can manage the worker nodes 110, 112 and the pods 120-124 of a cluster 102. The control plane 108 (and its components) may run across multiple computers. In the depicted example of system 100, the control plane 108 may include a controller manager 114, a ConfigMap manager 116, and an event log 118.

The controller manager 114 may run controller processes, where a controller may be a control loop that watches a shared state of the cluster 102 and makes changes to move the current state towards a desired state (which may be specified through user modifications, for example). The controller manager 114 may run controller processes for default Kubernetes controllers, as well as for controllers implemented by custom operators (e.g., ConfigMap manager 116). Accordingly, the controller manager 114 may implement the management functions controlled by custom operators such as ConfigMap manager 116. The controller manager 114 may operate together with other components of the control plane 108, such as an application programing interface (API) server and an etcd server (a key value store for cluster 102 data), to handle operations and data flow for the cluster 102.

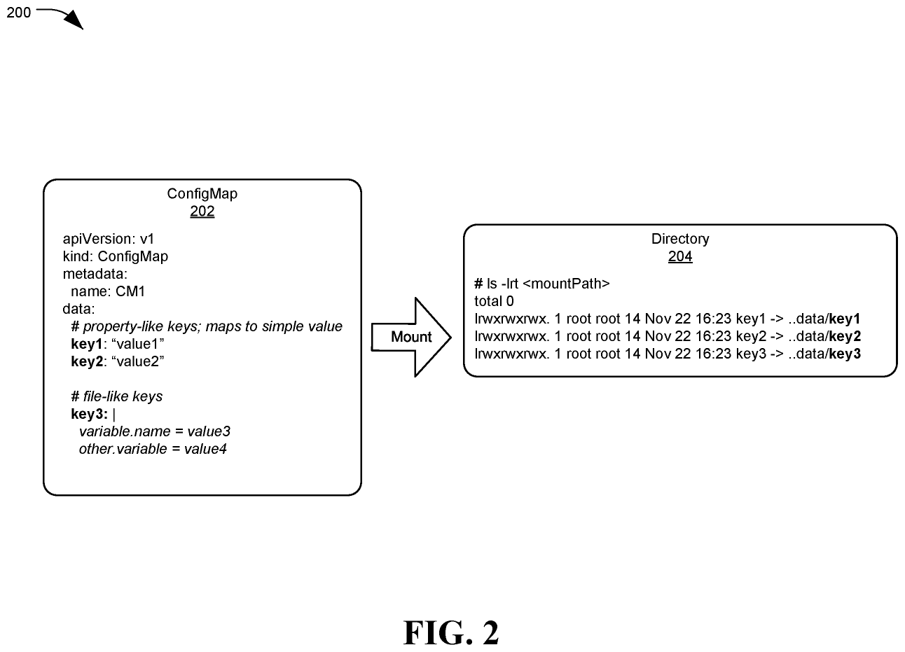

In one implementation, a ConfigMap may be mounted for use by one or more pods 120-124. When a new ConfigMap is needed for an already-running pod 120-124, a ConfigMap volume may be created for a namespace 126-128, and the application pod may need to be restarted to mount the ConfigMap to the pod to allow access. Similarly, when an already-mounted ConfigMap needs to be removed or deleted, it may need to be unmounted from application pod(s), which may then need to be restarted. The process of creating and mounting ConfigMaps, and application pod restarts, is discussed in further detail in regard to FIG. 2.

FIG. 2 is a diagram of a system 200 configured to perform configuration data management, in accordance with certain embodiments of the present disclosure. In particular, the example system 200 may depict data objects representing a ConfigMap 202 and a directory 204 that may be created when the ConfigMap 202 is mounted for use by an application pod.

A ConfigMap 202 may be created in a Kubernetes cluster based on, e.g., a yaml definition file creating key-value pairs for the ConfigMap. The definition file may define a name for the ConfigMap 202, a namespace in which the ConfigMap is to be created, what data elements and key-value pairs may be included in the ConfigMap, and other definition data. The ConfigMap 202 may include a data object having a variety of fields, such as an API Version, a “kind” of the object, a number of metadata fields (e.g., a ‘name’ for the object), and a number of ‘data’ fields. The data fields may include files, objects, or other data associated with the ConfigMap 202, such as key-value pairs. For example, ConfigMap 202 may include property-like keys, each of which may map to a simple value (e.g., a number or a text string), as well as file-like keys, which may map to a set of variable names and value sets.

The ConfigMap 202 may be accessed by application pods 120-124 through a volume mount operation, which may mount a volume or directory 204 to a pod 120-124. A volume may be a type of directory 204 which may be accessible to containers in a pod 120-124. The directory 204 may be located at a “mount path.” and may show files equal to the number of keys in the “data” field of ConfigMap 202. For example, the directory 204 may include files for “key1,” “key2”, and “key3” as in the ConfigMap 202.

Adding new configuration data may require mounting the ConfigMap 202 to a directory 204 to be accessible by a pod 120-124. However, the new ConfigMap 202 cannot be mounted on the same location or directory 204 as the first ConfigMap, because the new ConfigMap can contain the same fields as the first secret (e.g., key1, key2, key3), resulting in attempting to place multiple “files” with the same name in the same location. So to access a new ConfigMap, a new volumeMount may be needed with a new MountPath, which in turn may require restarting the pod(s) 120-124. Similarly, removing an existing ConfigMap 202 may include deleting an existing volumeMount directory 204, which can also require restarting the pod(s) 120-124. The process of restarting the application pods 120-124 every time a ConfigMap needs to be mounted or deleted can cause service interruptions or other problems. An alternative embodiment that avoids restarting the pods 120-124 is discussed herein.

Returning to FIG. 1, in another implementation, a ConfigMap manager 116 may be added to the Kubernetes cluster 102 and configured to manage ConfigMaps, so that ConfigMap data may be added to or removed from pods 120-124 without requiring the pods to be restarted. The ConfigMap manager 116 may include a Custom Operator (which in turn may have a custom controller), which can be added to the control plane 108. The ConfigMap manager 116 can create a new type of ConfigMap, which may be referred to as a super ConfigMap or SuperCM, such as SuperCM1 130, SuperCM2 132, and SuperCM1 134. A super ConfigMap can enable ConfigMaps to be added to or removed from a pod 120-124 without restarting the pod.

When a ConfigMap definition or yaml file is submitted, a ConfigMap resource may be generated, which may result in a state change. The controller manager 114 may watch for state changes (e.g., via a Kube API server), and details about the ConfigMap may be added to an event log 118. There may be separate event logs 118 for each namespace 126, 128, or a single event log may cover multiple namespaces. The ConfigMap manager 116 may monitor the event log(s) 118 (potentially for multiple or all namespaces 126, 128), either directly or through notifications from another component, such as the controller manager 114. The ConfigMap manager 116 may filter the events to only retrieve ConfigMaps containing a specified metadata label known by the ConfigMap manager 116. For example, a metadata label “cm-manager.io/identifier: <identifier Name>” may be added to ConfigMaps and recorded in the event log 118 along with newly created events, which label can be used to filter events 118 for relevant ConfigMaps by the ConfigMap manager 116. The ConfigMap manager 116 can be configured to recognize or use other key/value pairs for the searchable metadata or label. Based on the identifier label value (e.g., the <identifier name> value), the ConfigMap manager 116 can create a new super ConfigMap, having the label value as its own name, to act as a compilation of other ConfigMaps.

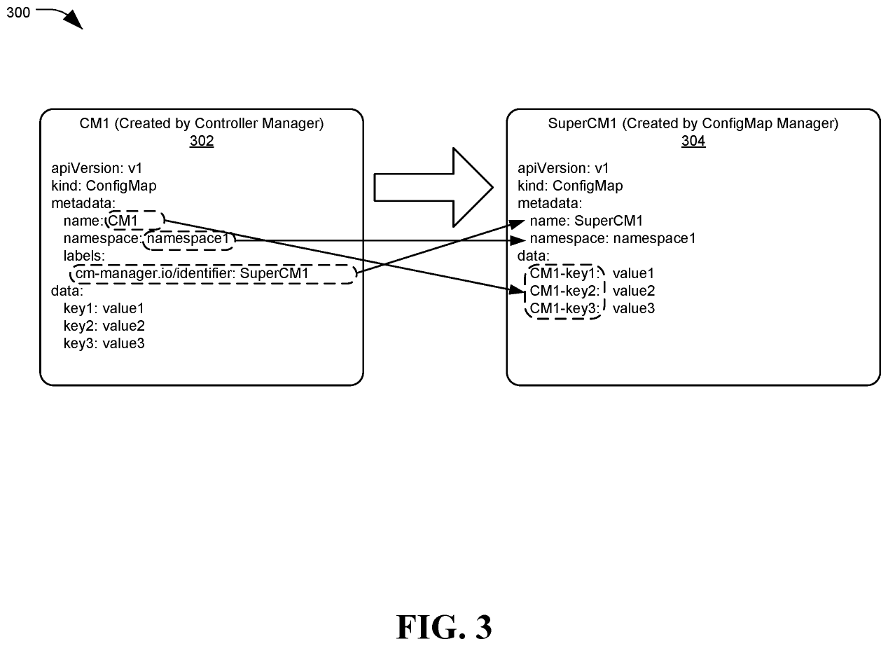

Super ConfigMaps may need to have unique names within a single namespace 126, 128, but not across namespaces. For example, a super ConfigMap with the name SuperCM1 130 can be created in namespace1 126, and another super ConfigMap with the same name, SuperCM1 134, can be created in namespace2 128. Another super ConfigMap, SuperCM2 132 having a different name can be added to the same namespace 1 126 as SuperCM1 130. All pods within a namespace may have access to the super ConfigMaps for that namespace, even across nodes 110, 112. For example, Pods A 120 and Pods C 124 in namespace 1 126 may have access to SuperCM1 130 and SuperCM 2 132. The creation of a super ConfigMap is discussed in further detail in regard to FIG. 3.

FIG. 3 is a diagram of a system 300 configured to perform configuration data management, in accordance with certain embodiments of the present disclosure. In particular, the example system 300 may depict data objects representing a ConfigMap (CM1) 302 and a super ConfigMap (SuperCM1) 304.

A CM1 302 may be created (for example, through a controller manager 114 triggering a creation event based on receipt of a yaml file). The CM1 302 may include a selected or specified metadata key/value identifier label (e.g., according to the definition file or added by a component of the containerized software environment during creation of the CM1 302). In this example, the identifier label may be “cm-manager.io/identifier”, and the identifier value may be “SuperCM1”. CM1 302 may also include a number of data elements, such as “key1”, “key2”, and “key3”. The creation of CM1 302 may be added to an event log 118, which may record some or all of the content of CM1 302 including the label.

The ConfigMap manager 116 may monitor the event log 118, filtered according to the identifier label (e.g., cm-manager.io/identifier). When a ConfigMap having an expected identifier label is found, the ConfigMap manager 116 may determine a namespace for the ConfigMap, and a value for the identifier. In this case, CM1 302 was created in namespace1, and the identifier value was SuperCM1.

The ConfigMap manager 116 may determine whether a super ConfigMap having a name equal to the identifier value exists in the determined namespace. If not, the ConfigMap manager 116 may create a new super ConfigMap in the identified namespace having a name set to the identifier value from CM1 302. In this case, the ConfigMap manager 116 would create a super ConfigMap named SuperCM1 304 in namespace1. The ConfigMap manager 116 may also copy the data elements or key files from CM1 302 to SuperCM1 304, while appending the name of CM1 or another selected modifier to the data fields. For example, this may add three data elements to SuperCM1 304, having appended key file names of CM1-key1, CM1-key2, and CM1-key3. In some examples, the selected modifier may include some other value associated with the originating ConfigMap CM1 302, such as a resource ID, hash or permutation of an element of CM1 302, or some other modifier to produce unique key file names. The values for the keys may be transferred unaltered from CM1 302 to SuperCM1 304. The newly created SuperCM1 304 may be mounted for access by one or more pods, potentially during initial creation or startup of a pod.

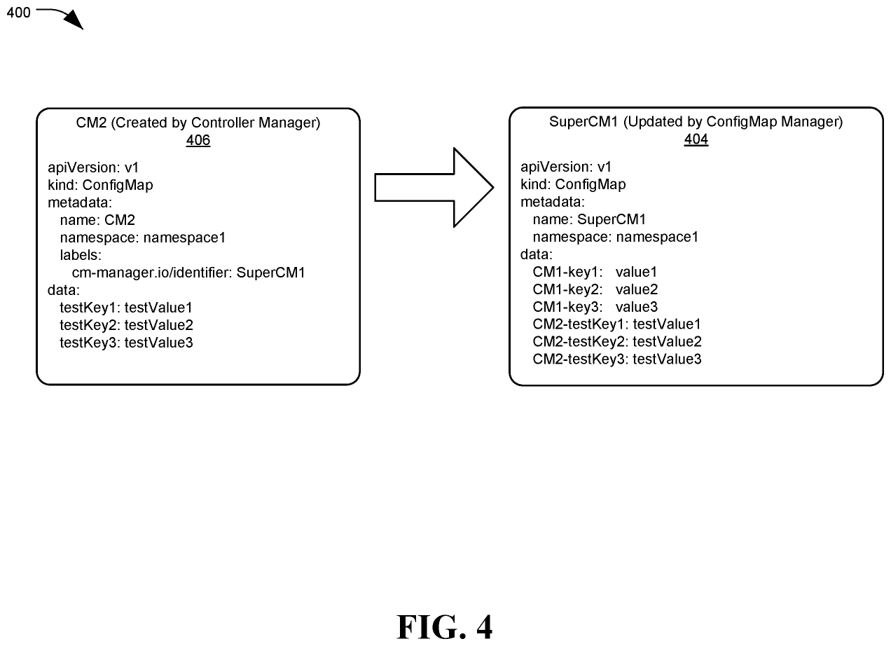

However, if a super ConfigMap with the identifier value from CM1 302 already exists in the namespace from CM1, then the ConfigMap manager 116 may perform a process as described in regard to FIG. 4.

FIG. 4 is a diagram of a system 400 configured to perform configuration data management, in accordance with certain embodiments of the present disclosure. In particular, the example system 400 may depict data objects representing a ConfigMap (ConfigMap2) 406 and a super ConfigMap (SuperCM1) 404.

Controller manager 114 may trigger creation of a new ConfigMap, CM2 406. Similar to CM1 302, CM2 406 may be created in namespace1, with identifier label cm-manager.io/identifier and identifier label SuperCM1. CM2 406 may include different key elements (e.g., testKey1, testKey2, and testKey3) from CM1 302, as shown in system 500. In some examples, CM2 406 could also have the same key elements as CM1 302 (e.g., key1, key2, and key3), but with different values.

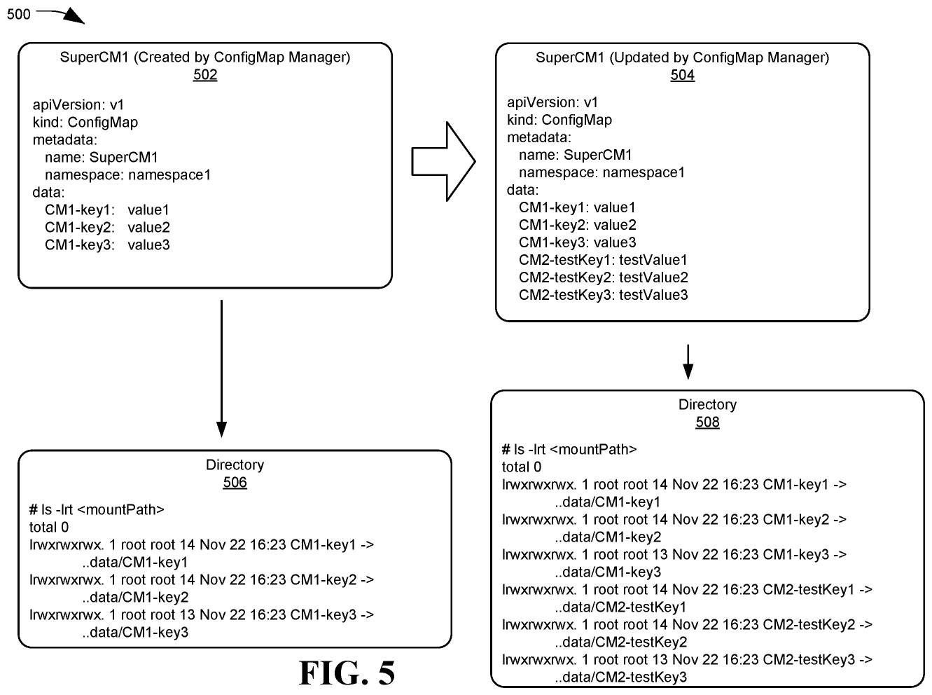

ConfigMap manager 116 may detect the creation of CM2 406 from event log 118 based on CM2 including a selected identifier label. Because the namespace and identifier value of CM2 406 matches an existing super ConfigMap, the ConfigMap manager 116 may not create a new super ConfigMap, and instead may update the existing SuperCM1 404. The ConfigMap manager 116 may update SuperCM1 404 by copying the key/value data elements from CM2 406 and appending the name of CM2 to the key names as described above (e.g., CM2-testKey1, CM2-testKey2, and CM2-testKey3). SuperCM1 404 may therefore include the key/value data elements from both CM1 302 and CM2 406. Even if the key elements from both CM1 302 and CM2 406 were the same, by appending the names of the different ConfigMaps the keys were from to the key names, they would end up having unique names (e.g., CM1-key1 and CM2-key1). Additionally, since SuperCM1 404 is already mounted for use by pods, there may be no requirement to restart a pod when CM2 406 data elements are added to SuperCM1 404, unlike if CM2 406 had to be mounted separately. Similarly, data elements may be removed from SuperCM1 404 without the need to restart any associated pods. The mounting of ConfigMaps is discussed in regard to FIG. 5.

FIG. 5 is a diagram of a system 500 configured to perform configuration data management, in accordance with certain embodiments of the present disclosure. In particular, the example system 500 may depict data objects representing SuperCM1 in its initially created state 502 and after being updated 504 with additional data objects, as well as corresponding initial directory 506 and updated directory 508.

A super ConfigMap created by ConfigMap manager 116 should be available for any pod(s) in the same namespace as the super ConfigMap. The super ConfigMap can be mounted on the pod(s) through volumeMount at a particular MountPath, which essentially creates a directory for the key/value data elements of the super ConfigMap to be available as files within the directory. Any addition, deletion, or update performed on a super ConfigMap can create or delete the equivalent files from the MountPath directory. As the addition, deletion, or update of the ConfigMap data elements causes changes within an existing MountPath directory, the pods to which the super ConfigMap is mounted do not need to be restarted for the changes to take effect.

As described in the example of FIG. 3, when SuperCM1 502 is initially created, it may include three key/value pair data elements corresponding to a CM1 302: CM1-key1, CM1-key2, and CM1-key3. SuperCM1 502 may be mounted at a selected mountPath, creating directory 506 including three files within it, corresponding to the three data keys from SuperCM1 502.

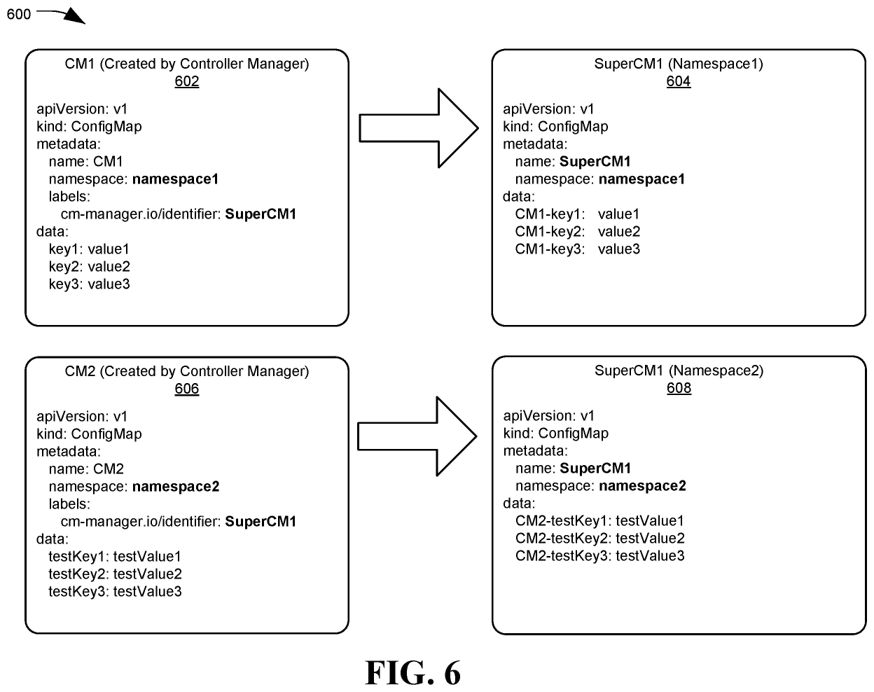

As described in the example of FIG. 4, SuperCM1 504 may be updated with three additional key/value data elements corresponding to CM2 406: CM2-testKey1, CM2-testKey2, and CM2-testKey3. Updating SuperCM1 504 did not change the mountPath, and instead merely added additional files to the updated directory 508, corresponding to the new keys from CM2 406. No mounting or unmounting may be required to update the directory 508 with the additional ConfigMap data elements, and accordingly no pods must be restarted to access those data elements. An example process of adding a new ConfigMap with a same identifier label value in different namespaces is discussed in regard to FIG. 6.

FIG. 6 is a diagram of a system 600 configured to perform configuration data management, in accordance with certain embodiments of the present disclosure. In particular, the example system 600 may depict data objects representing a first ConfigMap, CM1 602, created in a first namespace (namespace1) and resulting in the creation of a first super ConfigMap in the first namespace, SuperCM1 (namespace1) 604. Further, system 600 may include data objects representing a second ConfigMap, CM2 606, created in a second namespace (namespace2) and resulting in the creation of a second super ConfigMap in the namespace2. SuperCM1 (namespace2) 608, that shares the same name as the super ConfigMap from namespace1.

As described above, a super ConfigMap created by the ConfigMap manager 116 may be created or updated in the same namespace as the ConfigMap for which the ConfigMap manager received the event notification. While there cannot be two ConfigMaps in a single namespace with the same name, there may be two ConfigMaps with the same name in different namespaces. Therefore, there can be two super ConfigMaps with same name (e.g., SuperCM1) in two different namespaces.

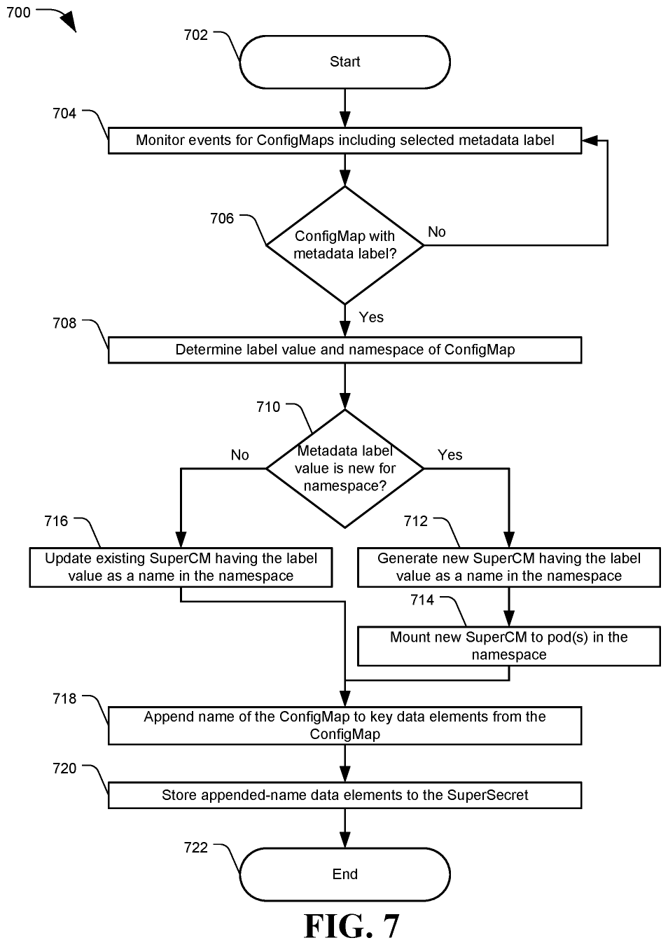

As an example, CM1 602 may be created in namespace1, having a identifier label value of “SuperCM1”. The ConfigMap manager 116 may detect the event for the creation of CM1 602 in namespace1, and when there is no existing super ConfigMap in namespace1 named SuperCM1, may create SuperCM1 (namespace1) 604. The ConfigMap manager 116 may then detect an event for the creation of CM2 606 in namespace2, also having an identifier label value of SuperCM1. Even though there is a SuperCM1 604 in namespace1, there may be no SuperCM1 in namespace2, and accordingly the ConfigMap manager 116 may generate SuperCM1 (namespace2) 608, without causing any name conflicts in the Kubernetes cluster. An example process flow for super ConfigMap generation is described in regard to FIG. 7.

FIG. 7 depicts a flowchart 700 of an example method to perform configuration data management, in accordance with certain embodiments of the present disclosure. In particular, FIG. 7 may illustrate a process flow by which a super ConfigMap may be generated or updated as new ConfigMaps are generated, which super ConfigMaps may be accessed by application pods without the need to restart the pods. The method may be performed by devices and systems described herein, such as the control plane 108 and ConfigMap manager 116 of FIG. 1.

The method may start at 702, and include monitoring events within a cluster for the creation or adding of ConfigMaps that include a selected metadata label, at 704. At 706, a determination may be made whether a particular ConfigMap includes the selected metadata label. If not, the method may include continuing to monitor for appropriate ConfigMaps, at 704.

When the ConfigMap does include the selected metadata label, at 706, the method may include determining a label value and a namespace of the ConfigMap, at 708. At 710, the method may include determining whether the metadata label value is new for the namespace. For example, the method may include checking whether there are any existing secrets or super secrets having a name that matches the metadata label already created or mounted in the particular namespace.

When the metadata label value is new (e.g., does not match an existing ConfigMap), the method may include generating a new SuperCM having the label value as a name in the namespace, at 712, and potentially mounting the new SuperCM to one or more pods in the namespace (e.g., via a volumeMount operation to a selected MountPath accessible to one or more pods within the namespace). On the other hand, if the metadata label value from the ConfigMap is not new for the namespace, at 710, the method may include updating an existing SuperCM having the label value as a name in the namespace, at 716.

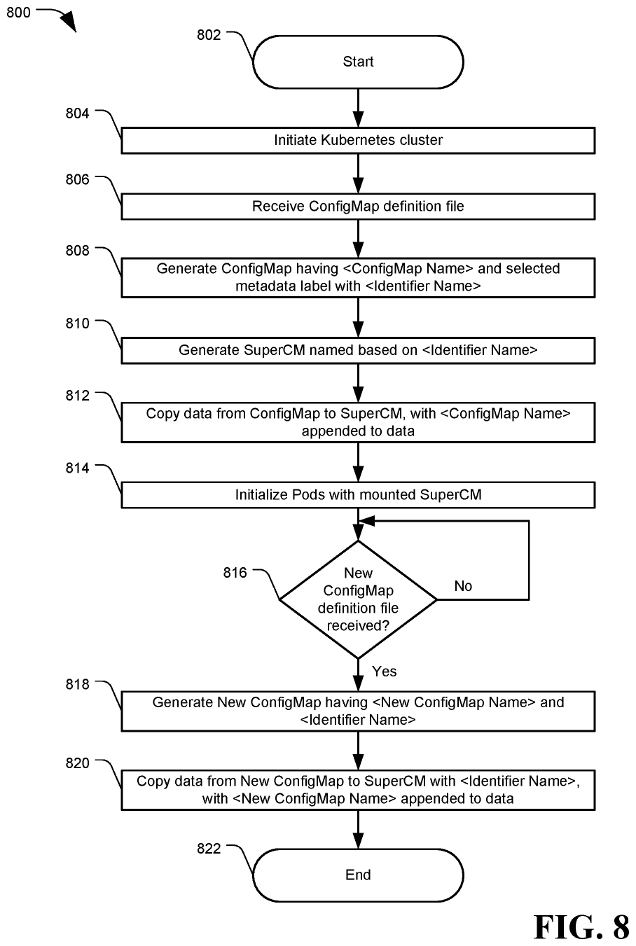

After creating a new SuperCM, at 712 and 714, or updating an existing SuperCM, at 716, the method may include appending a name of the ConfigMap to key data elements from the ConfigMap, at 718. This may ensure each key data element from different ConfigMaps has a unique name within the namespace. At 720, the method may include storing the appended-name data elements to the SuperCM, or to a directory or MountPath for the SuperCM. The method may then end at 722, or return to monitoring events for ConfigMaps, at 704. An example of super ConfigMap creation based on a received definition file is described in regard to FIG. 8.

FIG. 8 depicts a flowchart 800 of an example method to perform configuration data management, in accordance with certain embodiments of the present disclosure. In particular, FIG. 8 may illustrate a process flow by which a super ConfigMap may be generated in response to receipt of a definition file or manifest in a Kubernetes cluster. The method may be performed by devices and systems described herein, such as the control plane 108, and controller manager 114 and ConfigMap manager 116 of FIG. 1.

The method may start at 802, and may include initiating a Kubernetes cluster, at 804. Initiating the cluster may include allocating a number of nodes on which to run one or more pod(s), as well as implementing a control plane 108 including a number of elements for managing the pod(s). The control plane 108 may include a controller manager 114, a ConfigMap manager 116, and an event log 118.

The method may include receiving a ConfigMap definition file (e.g., a yaml file), for example via the control plane 108, at 806. At 808, the method may include generating a ConfigMap (e.g., orchestrated via controller manager 114) having a <ConfigMap Name>, and a selected metadata label with an associated label value of <Identifier Name>. The generation of the ConfigMap may be reflected in an event log, which a ConfigMap manager 116 may filter for ConfigMaps containing the selected metadata label.

When a ConfigMap with the selected metadata label is identified, the method may include generating a SuperCM having a name based on the <Identifier Name> from the ConfigMap, at 810. At 812, the method may include copying key data elements from the ConfigMap to the SuperCM, with <ConfigMap Name> appended to the key data elements. As part of the initialization of the Kubernetes cluster, the method may include initializing one or more pods, with the SuperCM mounted to provide the pods access to the data elements, at 814.

At 816, the method may include determining whether a new ConfigMap definition file has been received. If not, the method may include continuing to monitor for new ConfigMap definition files, at 816. When a new ConfigMap definition file has been received, at 818, the method may include generating a New ConfigMap having <New ConfigMap Name> as a name, and <Identifier Name> for the metadata label, matching the prior <Identifier Name> from the previous ConfigMap. The method may include copying data from the New ConfigMap to the existing SuperCM with a name of <Identifier Name>, while appending <New ConfigMap Name> to the data names, at 820. The method may then end, at 822, or return to monitoring for new certificates, at 816. In some examples, the method 800 may include monitoring for deletion or update events for any of the ConfigMaps associated with a SuperCM, and removing or updating the key/value data in the SuperCM.

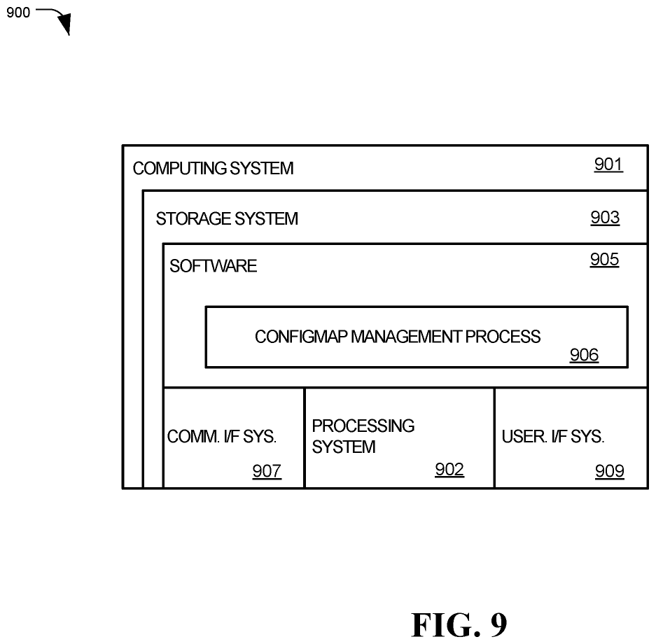

The solutions described herein, of adding, deleting, or updating ConfigMap associated with a super ConfigMap, may not require restarting the pod(s) for which the super ConfigMap is mounted, as all the ConfigMap files will be available under the same MountPath. Adding a new ConfigMap will result in having the new files available in the same MountPath. The application pod(s) then can access the required configuration data by checking the prefix of the files available in the MountPath. Although the examples provided herein describe adding new ConfigMap files to a super ConfigMap, the benefits similarly extend to removing ConfigMap files without the requirement to restart an application pod. For example, after a ConfigMap expires or is selected for removal, an operation can be performed to delete or remove the selected ConfigMap files from the super ConfigMap while the super ConfigMap remains mounted. A computing system configured to perform the operations and methods described herein is provided in regard to FIG. 9.

FIG. 9 illustrates an apparatus 900 including a computing system 901 that is representative of any system or collection of systems in which the various processes, systems, programs, services, and scenarios disclosed herein may be implemented. For example, computing system 901 may be an example of Kubernetes Cluster 102, Node 1 110, Node 2 112, Control Plane 108, controller manager 114, ConfigMap manager 116, or Events 118 of FIG. 1. Examples of computing system 901 include, but are not limited to, server computers, desktop computers, laptop computers, routers, web servers, cloud computing platforms, and data center equipment, as well as any other type of physical or virtual server machine, physical or virtual router, container, and any variation or combination thereof.

Computing system 901 may be implemented as a single apparatus, system, or device or may be implemented in a distributed manner as multiple apparatuses, systems, or devices. Computing system 901 may include, but is not limited to, processing system 902, storage system 903, software 905, communication interface system 907, and user interface system 909. Processing system 902 may be operatively coupled with storage system 903, communication interface system 907, and user interface system 909.

Processing system 902 may load and execute software 905 from storage system 903. Software 905 may include and implement ConfigMap management process 906, which may be representative of any of the operations for generating or removing ConfigMaps or super ConfigMaps, receiving definition files, mounting volumes or creating directories, or other ConfigMap management operations discussed with respect to the preceding figures. When executed by processing system 902 to determine and implement a secret management process, software 905 may direct processing system 902 to operate as described herein for at least the various processes, operational scenarios, and sequences discussed in the foregoing implementations. Computing system 901 may optionally include additional devices, features, or functionality not discussed for purposes of brevity.

In some embodiments, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 may include general purpose central processing units, graphical processing units, application specific processors, and logic devices, as well as any other type of processing device, combinations, or variations thereof.

Storage system 903 may comprise any memory device or computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including ConfigMap management process 906 among other functions) may be implemented in program instructions that may, when executed by processing system 902, direct processing system 902 to operate as described with respect to the various operational scenarios, sequences, and processes illustrated herein. For example, software 905 may include program instructions for receiving definition files, generating or removing ConfigMaps, monitoring event logs, generating super ConfigMaps, copying ConfigMap key data files or elements, and mounting volumes or directories for use by application pods, as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to implement a bundled binding audit process as described herein. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

While some examples provided herein are described in the context of Kubernetes containerized software environments, it should be understood the systems and methods described herein for configuration data management are not limited to such embodiments, and may apply to a variety of other containerized or virtualized software environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise.” “comprising.” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein.” “above.” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A configuration data management system, comprising:
one or more processors; and
a memory having stored thereon instructions that, upon execution by the one or more processors, cause the one or more processors to implement a configuration data management process to enable ConfigMaps to be added to an application pod of a virtual software environment without restarting the application pod, a ConfigMap including a data object containing configuration data, the configuration data management process including:
monitor for creation of a first ConfigMap in the virtual software environment;
append a name of the first ConfigMap to a data element name from the first ConfigMap to produce an appended data element; and
store the appended data element to a super ConfigMap, the super ConfigMap including a specialized ConfigMap configured to contain data elements from multiple ConfigMaps.

2. The configuration data management system of claim 1, further comprising instructions that, upon execution, cause the one or more processors to:
determine whether the first ConfigMap includes a selected metadata label; and
in response to determining the first ConfigMap includes the selected metadata label,
determine a first value associated with the selected metadata label and a first namespace associated with the first ConfigMap; and
determine whether the first value corresponds to an existing super ConfigMap in the first namespace.

3. The configuration data management system of claim 2, further comprising instructions that, upon execution, cause the one or more processors to:
in response to determining the first value does correspond to an existing super ConfigMap in the first namespace, store the appended data element to the super ConfigMap as the existing super ConfigMap.

4. The configuration data management system of claim 3, further comprising instructions that, upon execution, cause the one or more processors to:
detect creation of a second ConfigMap having:
a second namespace associated with the second ConfigMap;
the selected metadata label; and
a second value associated with the selected metadata label that is the same as the first value;
determine whether the second namespace is the same as the first namespace;
when the second namespace is different than the first namespace,
generate a new super ConfigMap in the second namespace; and
store a second appended data element from the second ConfigMap to the new super ConfigMap; and
when the second namespace is the same as the first namespace,
store the second appended data element from the second ConfigMap to the super ConfigMap in the first namespace.

5. The configuration data management system of claim 2, further comprising instructions that, upon execution, cause the one or more processors to:
in response to determining the first value does not correspond to an existing super ConfigMap in the first namespace, generate the super ConfigMap, including setting a name for the super ConfigMap based on the first value.

6. The configuration data management system of claim 5, further comprising instructions that, upon execution, cause the one or more processors to:
mount the super ConfigMap to the application pod during initialization of the application pod, including storing the appended data element to a directory accessible to the application pod.

7. The configuration data management system of claim 2, further comprising instructions that, upon execution, cause the one or more processors to:
in response to the first ConfigMap not including the selected metadata label, do not append the name of the first Configmap to the data element name or store the appended data element to the super ConfigMap.

8. The configuration data management system of claim 1, further comprising instructions that, upon execution, cause the one or more processors to:
mount the super ConfigMap to the application pod to provide a directory via which the application pod can access the appended data element; and
configure the super ConfigMap such that additional appended data elements from ConfigMaps can be added to or removed from the directory during operation of the application pod, without requiring a restart of the application pod.

9. The configuration data management system of claim 1, further comprising instructions that, upon execution, cause the one or more processors to:
detect creation of a second ConfigMap in the virtual software environment;
append a second name of the second ConfigMap to a second data element from the second ConfigMap to produce a second appended data element; and
store the second appended data element to the super ConfigMap.

10. The configuration data management system of claim 1, further comprising instructions that, upon execution, cause the one or more processors to:
initiate the virtual software environment as a Kubernetes cluster;
initiate the application pod after initiation of the Kubernetes cluster;
mount the super ConfigMap to the application pod during initiation of the application pod;
add data element key files to the super ConfigMap without restarting the application pod; and
remove the data element key files from the super ConfigMap without restarting the application pod.

11. A method comprising:
operating a configuration data management system to ConfigMaps to be added to an application pod of a virtual software environment without restarting the application pod, a ConfigMap including a data object containing configuration data, including:
monitoring for creation of a first ConfigMap in the virtual software environment;
appending a selected value derived from the first ConfigMap to a data element name from the first ConfigMap to produce an appended data element; and
storing the appended data element to a super ConfigMap, the super ConfigMap including a specialized ConfigMap configured to contain data elements from multiple ConfigMaps.

12. The method of claim 11 further comprising:
determining whether the first ConfigMap includes a selected metadata label; and
determining whether to store the appended data element to the super ConfigMap based on whether the first ConfigMap includes the selected metadata label.

13. The method of claim 12, further comprising:
in response to determining the first ConfigMap includes the selected metadata label,
determining a first value associated with the selected metadata label and a first namespace associated with the first ConfigMap; and
determining whether the first value corresponds to an existing super ConfigMap in the first namespace.

14. The method of claim 13, further comprising:
in response to determining the first value does correspond to an existing super ConfigMap in the first namespace, storing the appended data element to the super ConfigMap as the existing super ConfigMap; and
in response to determining the first value does not correspond to an existing super ConfigMap in the first namespace, generating the super ConfigMap, including setting a name for the super ConfigMap based on the first value.

15. The method of claim 14, further comprising:
detecting creation of a second ConfigMap having:
a second namespace associated with the second ConfigMap;
the selected metadata label; and
a second value associated with the selected metadata label that is the same as the first value;
determining whether the second namespace is the same as the first namespace;
when the second namespace is different than the first namespace,
generating a new super ConfigMap in the second namespace; and
storing a second appended data element from the second ConfigMap to the new super ConfigMap; and
when the second namespace is the same as the first namespace,
storing the second appended data element from the second ConfigMap to the super ConfigMap in the first namespace.

16. The method of claim 13, further comprising:
receiving a definition file that defines attributes of the first ConfigMap; and
generating the first ConfigMap to have a name of the first ConfigMap, the first namespace of the first ConfigMap, and the selected metadata label based on the definition file; and
setting the selected value to the name of the first ConfigMap.

17. The method of claim 12, further comprising:
in response to the first ConfigMap not including the selected metadata label, not appending the selected value derived from the first ConfigMap to the appended data element or storing the appended data element to the super ConfigMap.

18. The method of claim 11, further comprising:
detecting creation of a second ConfigMap in the virtual software environment;
appending a second selected value derived from the second ConfigMap to a second data element from the second ConfigMap to produce a second appended data element; and
store the second appended data element to the super ConfigMap.

19. The method of claim 11, further comprising:
in response to detecting creation of the first ConfigMap, generating the super ConfigMap;
mounting the super ConfigMap to the application pod during initialization of the application pod, including storing the appended data element to a directory accessible to the application pod; and
configuring the super ConfigMap such that additional appended data elements from ConfigMaps can be added to or removed from the directory during operation of the application pod, without requiring a restart of the application pod.

20. The method of claim 11, further comprising:
initiating the virtual software environment as a Kubernetes cluster;
initiating the application pod after initiation of the Kubernetes cluster;
mounting the super ConfigMap to the application pod during initiation of the application pod;
adding data element key files to the super ConfigMap without restarting the application pod; and
removing the data element key files from the super ConfigMap without restarting the application pod.
